(19) United States
(12) Patent Application Publication
(10) Pub. No.: US 2005/0149437 A1
(43) Pub. Date: Jul. 7, 2005

(54) Method, system, and storage medium for managing electronic transactions

(76) Inventors: Samuel N. Zellner, Dunwoody, GA (US); John A. Pumpelly, Atlanta, GA (US)

Correspondence Address: CANTOR COLBURN LLP, 55 GRIFFIN ROAD SOUTH, BLOOMFIELD, CT, 06002, US

(21) Appl. No.: 10/750,695

(22) Filed: Jan. 2, 2004

(51) Int. Cl. G06F 17/60

(52) U.S. Cl. 705/39

(57) ABSTRACT

Embodiments of the invention relate to a method, system, and storage medium for providing control over transactions. The method includes prompting a primary user to input financial notification data. The financial notification data is used to define transaction controls associated with a secondary user. The method also includes receiving and storing the financial notification data. The method further includes receiving data relating to a financial transaction from a point of sale. The data is associated with the secondary user. The method also includes retrieving financial notification data related to the financial transaction and sending a notification to the point of sale based upon the data relating to the financial transaction.

### BACKGROUND OF THE INVENTION

Embodiments of the invention relate generally to financial transactions, and more particularly, to a method, system, and storage medium for providing control over transactions or services.

Consumers and businesses today rely heavily on electronic purchasing through the use of credit accounts, debit accounts, pre-paid merchant accounts, postpaid services such as cellular telephone services, e-commerce systems, video-on-demand, etc. Oftentimes, consumers provide access to their accounts, or provide financial assistance, to family members such as children in an effort to assist in college expenses, emergency situations, and to teach a child critical budgeting and financial lessons. Sharing an account with a family member can bring much needed peace of mind to the account owner. Sharing the use of a credit account or account requires that the primary account holder possess some level of trust that the secondary user will not abuse the account and that the use will be limited to the transactions agreed to upon by the parties at the time the account is shared. Similarly, businesses provide capabilities for their employees to conduct financial transactions as an agent of the company in conducting business (e.g., business travel, purchasing of equipment or supplies, cellphone, etc.). Unfortunately, the primary account holder does not typically learn of any abuses until a bill is generated and transmitted to the primary account holder, usually spanning a 21-25 day billing cycle. Most financial institutions and retail/service establishments provide limits to spending in order to prevent such abuses. Again, however, the knowledge and nature of any abuse is not conveyed to the primary account holder until a bill is generated. Other companies such as cellular service providers often do not provide limits. Thus, tracking and controlling the transactions of a secondary user are fraught with disadvantages.

What is needed, therefore, is a way to provide broad customizable controls over various financial transactions conducted by a secondary user on behalf of a primary account holder.

### SUMMARY OF THE INVENTION

Embodiments of the invention relate to a method, system, and storage medium for providing control over transactions. The method includes prompting a primary user to input financial notification data. The financial notification data is used to define transaction controls associated with a secondary user. The method also includes receiving and storing the financial notification data and receiving data relating to a financial transaction from a point of sale location. The data is associated with the secondary user. The method also includes retrieving financial notification data related to the financial transaction and sending a notification to the point of sale location based upon the data relating to the financial transaction.

Embodiments also include a system, a storage medium and a database for providing control over transactions. Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of a system upon which the transaction control system is implemented in exemplary embodiments of the invention;

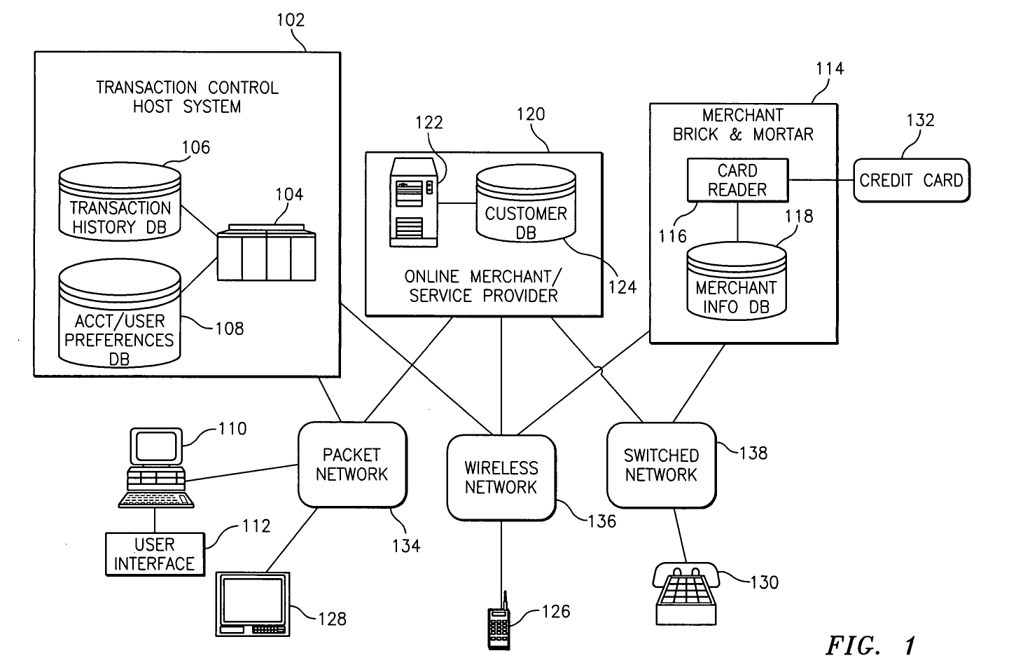

FIG. 2 is a flowchart describing the process of setting user preferences by a primary account holder via the transaction control system in exemplary embodiments of the invention;

FIG. 3 is a sample user interface screen as seen by a primary account holder of the transaction control system for use in creating/editing user preferences in exemplary embodiments of the invention; and

FIG. 4. is a flowchart describing the process of executing a transaction utilizing the transaction control system in exemplary embodiments of the invention.

### DETAILED DESCRIPTION OF THE INVENTION

The transaction control system services provided in system 100 of the invention offer a solution to problem spending or other transactions. The transaction control system allows for automatic and user-customized control over transactions at a point of sale (POS). This control is based upon policy decisions established by a primary account holder and is implemented for secondary users associated with the primary account holder. Automatic notification of these transactions is also provided by the transaction control system. A primary account holder refers to an individual that has ownership of, and/or maximum control over, an account that is subject to the transaction control system services of the invention. This is typically the individual who opened the account and who is financially and legally responsible for the account. A secondary user refers to an individual that shares access of the account with the primary account holder and for which the primary account holder desires to limit access. A transaction refers to any activity that is requested with respect to an account, such as a purchase, a request for balance, legal inquiries such as terms and conditions for the transaction, and may include debit and/or credit transactions.

System 100 includes a transaction control host system 102. Transaction control host system 102 may be an Application Services Provider (ASP) that provides transaction control services to registered individuals (also referred to herein as “primary account holders”) for a fee. Alternatively, transaction control host system 102 may be a commercial entity such as a credit account company, a bank, an Internet service provider, or other such entity that provides transaction control host services to primary account holders as a value added service. Transaction control host system 102 comprises a server 104 that executes the transaction control system on behalf of primary account holders. Also provided by transaction control host system 102 are a transaction history database 106 and a user preferences database 108. Transaction history database 106 records electronic transactions associated with secondary users. Secondary users refer to those individuals for whom a primary account holder shares access to an account and whereby the primary account holder desires to monitor and control the financial activities of the secondary users. Secondary user controls and limitations are specified by the primary account holder in accordance with user preferences. User preferences are defined by the primary account holder via the transaction control system and stored in user preferences database 108. In addition to personal consumers, a primary account holder may also be a merchant or a service provider that utilizes the services of the transaction control system.

Client system 110 refers to a computing device such as a general-purpose desktop computer or laptop. Client system 110 may be operated by a primary account holder when registering to use the transaction control services or for creating and editing user preferences. Registration is performed by transaction control host system 102 via packet-switched network 134. Client system 110 may also be operated by a secondary user that requests execution of an electronic transaction over a network. A secondary user of client system 110 may be in communication with an online merchant 120 or service provider via packet-switched network 134. The primary account holder accesses the transaction control system application via a user interface 112 that guides the primary account holder through the registration process as well as establishing user preferences. User interface 112 may be implemented as a modification to an existing commercial application interface or may be a standalone application. A secondary user on client system 110 may request execution of electronic transactions such as participating in online gaming, purchasing goods and services from an online merchant or website, use of a service account, as well as other similar types of activities.

Merchant 114 refers to a physical establishment for a commercial enterprise. Merchant 114 may be a department store, a grocery store, a liquor store, a gas station, or any retail/wholesale establishment that provides goods and services to others. Merchants typically accept some type of credit account, debit account, department store account, or pre-paid account including gift certificates. Merchant 114 employs an account reader device for electronically capturing credit account 132 information from a secondary user customer upon checkout. Merchant information database 118 stores records of data relating to its customers who are credit account holders with the merchant or individuals that may be on a mailing list for the merchant. Merchant information database 118 also stores specific merchant information such as store identification (if a chain store), promotional offerings and discounts, and other similar information.

Online merchant/service provider 120 refers to an establishment that maintains a web presence such that customers may purchase goods and/or services by accessing the online merchant/service provider 120 over a network. Examples of online merchants include department stores, online establishments (e.g., E-bay™, Amazon.com™), software providers that enable customers to download applications, etc. Online merchant/service provider 120 also includes a customer database 124 that stores customer account information and related data. In a further embodiment, online merchant/service provider 120 may be a telephone service provider that provides wireline and/or wireless telephone access and services to customers. In yet a further embodiment, online merchant/service provider 120 is a cable television service provider that provides cable television, pay-per-view movies, and/or cable Internet services to customers.

Merchant 114 and/or online merchant/service provider 120 may provide transaction control services to customers acting as a host system of the transaction control services (e.g., without the assistance of host system 102). In this manner, merchant 114 and/or online merchant/service provider 120 execute the transaction control system and store related user preference records, or alternatively, may outsource the management of the transaction control activities to a third party entity. The implementation of the transaction control system is described herein with respect to a third party host system 102 that offers the transaction control services to merchants such as merchant 114 and/or online merchant/service provider 120. In this manner, merchant 114 and online merchant/service provider 120 are customers of the transaction control system services, which, in turn, provide these services to their customers.

System 100 further comprises a wireless communications device 126, a television 128, and a wireline telephone 130. Wireless communications device 126 may be any communications device that provides voice, radio and/or digital communications to subscribing customers via wireless network 136. For example, communications device 126 may be a cellular telephone, a personal digital assistant (PDA), a pager, or a remote computer laptop, to name a few. Television 128 receives broadcast and cable signals to customers where online merchant/service provider 120 is a cable television service provider. Wireline telephone 130 comprises a telephone that subscribes to a telephone service and receives communications via a public switched telephone network (PSTN). A user of telephone 130 may be a primary account holder that registers with the transaction control host system 102 via telephone 130 in order to receive the services described herein. In this manner, the primary account holder is in direct communication with transaction control host system 102 via telephone 130. A user of telephone 130 may also be a secondary user for which a primary account holder has specified transaction control rules that prescribe the nature and extent of telephone use authorized for the secondary user. Where online merchant/service provider 120 is a telephone service provider, the secondary user of telephone 130 would execute a transaction (i.e., telephone call) and the telephone service provider 120 communicates with transaction control host system 102 in determining any transaction rules in place for the secondary user.

Credit account 132 may be a bank account, a department store account, a pre-paid account, a debit account, or other similar type of account.

In a further embodiment, merchants 114 and/or online merchant/service provider 120 host some or all of the transaction control system software for implementing the transaction control services. For example, merchant 114 is a national department store chain. Merchant 114 executes the transaction control system software and stores the transaction history and user preferences in a central location such as a corporate office. The user preferences and transaction rules selectable by a primary account holder would then be limited to the merchant store and would not apply to other commercial establishments.

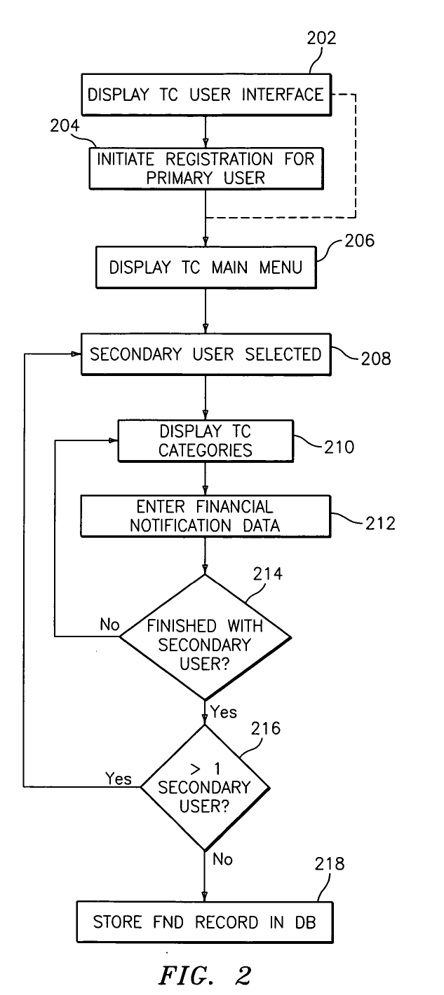

As indicated above, the transaction control system allows for automatic control over secondary user transactions based upon policy decisions established by the primary account holder. FIG. 2 describes the process of implementing registration and for managing user preferences for the transaction control system. While a primary account holder may register for the transaction control system via any communications channel, the registration and account set up will be described herein with respect to a computer-implemented registration. This computer-based registration description is presented for illustrative purposes only and should not be construed as limiting in scope. Thus, other forms of registration activities may be conducted such as telephone registration, in person registration, etc.

At step 202, a user interface 112 is presented to client system 110 upon accessing the transaction control system online. New users may register to use the service at step 204. If already registered, the primary account holder may skip to the main menu at step 206. The registration process involves collecting personal data from the registrant (i.e., primary account holder) such as name, address, and password set up. At step 206, a main menu is presented to the primary account holder. The primary account holder enters a secondary user for which transaction controls are requested. As indicated above, this is typically a family member of the primary account holder.

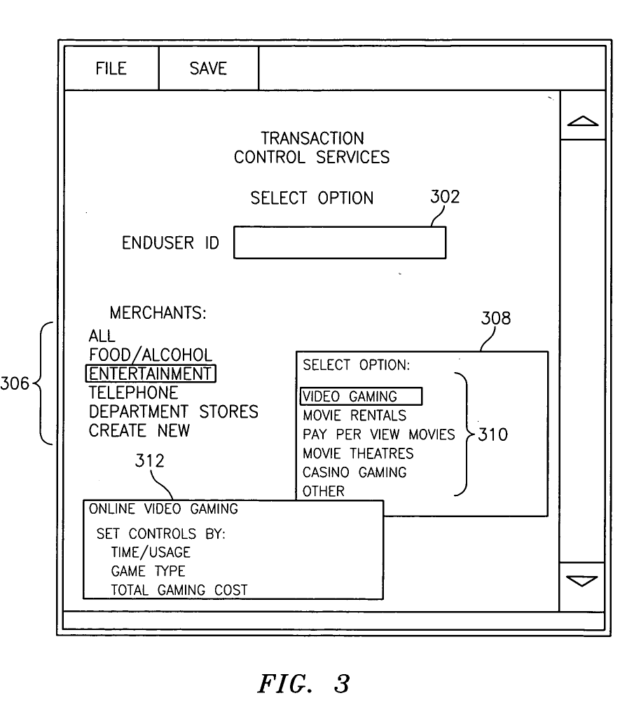

At step 210, a menu of transaction control items is presented to the primary account holder for a selected secondary user (302) as shown in computer screen 300 of FIG. 3. For illustrative purposes, transaction control items are organized by categories 306, although it will be understood by those skilled in the art that the data elements comprising the transaction controls may be presented in any organized manner. The primary account holder is prompted to enter financial notification data at step 212. Financial notification data includes a spending type, which is further broken down into a spending limit, a location type, a time of day, a type of purchase, and a type of merchant. A spending usage limit may be a daily limit, a weekly limit, a monthly limit, or other time-based limits. A spending limit may also be established as a total spending limit similar to that implemented in commercial credit account programs. The transaction control system provides the ability to distinguish between when a spending limit set by a primary account holder has been reached and when a spending limit set by a account granting company/account enterprise (i.e., the entity that services the account) has been reached. An type of purchase may refer to a general category of goods or services. For example, in the case of a credit or debit card, where a primary account holder has authorized purchases from a bookstore that also sells music, food, and gift items, the primary account holder may specify that only books may be approved by the merchant. A type of purchase may also distinguish between types of purchases such as online purchases versus in-store purchases. In the example window screen 300 of FIG. 3, the primary account holder has selected ‘entertainment’ 306. A selection of sub-options 310 for the entertainment control item 306 is presented to the primary account holder in sub-window 308. The transaction control system allows primary account holders to select and define financial notification data for various types and categories of elements as described herein. Transaction control items 306 reflect generalized categories such as food/alcohol, entertainment, telephone, and department stores. A primary account holder may also select ‘ALL’ categories for setting broad-based controls or may create a new category if desired. In the example provided in FIG. 3, the primary account holder has selected ‘video gaming’ 310 from entertainment category 306 resulting in a subwindow 312 that provides more specific transaction control rules. Financial notification data also includes rules that enable a primary account holder to define when and how a notification of a transaction and/or transaction request will be presented. For example, a notification may occur by printing notification data on a customer receipt, by person-to-person at the point of sale, by electronic messaging, telephone, postal mail, or any other communications means.

Once the financial notification data has been entered, the primary account holder is queried to see if all financial notification data has been entered for the selected secondary user at step 214. If not, the process returns to step 210 whereby the primary account holder may select new transaction control rules. Otherwise, the transaction control system queries the primary account to determine if there are other secondary users for whom the primary account holder would like to include at step 216. If there are no further secondary users, a transaction control record is generated for the secondary user and stored in database 108 at step 218. If additional secondary users are desired, then the process returns to step 208 and the primary account holder enters the name or identity information for the secondary user.

As indicated above, a primary account holder may be a merchant or service provider that registers with host system 102. In this case, the merchant or service provider would access the transaction control system and enter data as described above. Alternatively, merchant 114 and/or online merchant/service provider 120 may be hosting the transaction control system services whereby customer records are stored internally.

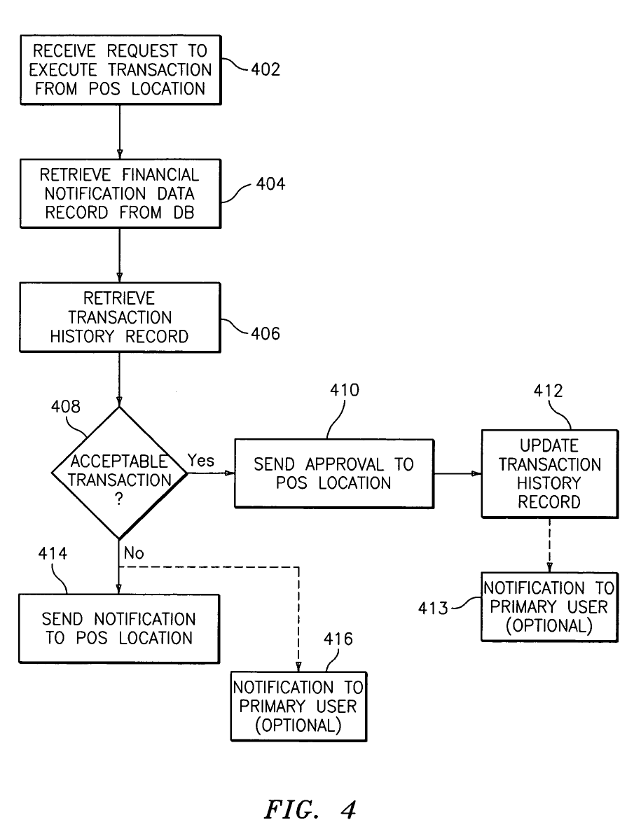

Once the primary account holder has registered and established a transaction control record, the transaction control system is ready to be implemented with regard to an secondary user affiliated with the primary account holder as described in FIG. 4.

At step 402, the transaction control system on server 104 receives a request to execute a transaction for a secondary user from a point of sale (POS) location. The transaction control system retrieves the transaction control record from user preferences database 108 at step 404. The transaction control system further retrieves a transaction history record from transaction history database 106 at step 406 and compares the requested transaction with the transaction control record and history record. Based upon the rules defined in the transaction control record and the data provided in the transaction history record, the transaction control system performs one of several possible actions. If the transaction is approved at step 408, the transaction control system sends a notification of approval to execute the transaction at step 410 to the requesting entity at the POS location (e.g., merchant 114, online merchant/service provider 120). The approval and the corresponding data are updated in the transaction history record at step 412. Optionally, a notification relating to the transaction and/or transaction request may be sent to the primary account holder at step 413. If the transaction is not acceptable at step 408, the transaction control system sends a notification to the POS location in accordance with the financial notification data associated with the secondary user. The notification may be a warning to the secondary user, a rejection of the transaction sent to the POS location, a request to check ID of the secondary user, a request for an additional authorization code, or other similar notifications. A warning may involve approving the transaction but including a notice of suspension of account privileges (e.g., a account 132 shut-off). The primary account holder may be notified as well (optional) at step 416.

Through the use of transaction parameters for controls defined by the transaction control system, a primary account holder can manage and set limits on various electronic transactions for secondary users such as family members. The transaction control system may be implemented by, or on behalf of, a single commercial entity such as a department store chain, or may be implemented by a third party host system, such as an application service provider for businesses or commercial entities.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

1. A method for providing control over transactions, comprising:
prompting a primary user to input financial notification data, said financial notification data operable for defining transaction controls associated with a secondary user;
receiving and storing said financial notification data;
receiving data relating to a financial transaction from a point of sale, said data associated with said secondary user;
retrieving financial notification data related to said financial transaction; and
sending a notification to said point of sale based upon said data relating to said financial transaction.

2. The method of claim 1, wherein said financial notification data specify conditions for performing at least one of:
approving a request to execute said financial transaction;
denying a request to execute said financial transaction;
issuing a notification to said primary user in response to receiving a request to execute said financial transaction;
confirming an identity of said secondary user before approving said financial transaction; and
suspending future financial transaction activities of said secondary user.

3. The method of claim 1, wherein said financial notification data comprise a spending type, said spending type including at least one of:
a type of transaction;
a listing of items or services associated with said transaction;
a type of merchant;
a time of day; and
a location type.

4. The method of claim 3, wherein said spending type further comprises a spending or usage limit.

5. The method of claim 1, wherein said notification is presented via at least one of:
a point of sale terminal;
a transaction receipt;
a computer screen;
a telephone;
postal mail;
a messaging application; and
an online service.

6. The method of claim 1, wherein said notification comprises at least one of:
an account balance;
an account shut-off;
a denial of a request to execute said financial transaction;
a request for an additional authorization code; and
a request to check an identification of said secondary user.

7. A system for providing control over transactions, comprising:
a means for prompting a primary user to input financial notification data, said financial notification data operable for defining transaction controls associated with a secondary user;
a means for receiving and storing said financial notification data;
a means for receiving data relating to a financial transaction from a point of sale, said data associated with said secondary user;
a means for retrieving financial notification data related to said financial transaction; and
a means for sending a notification to said point of sale based upon said data relating to said financial transaction.

8. The system of claim 7, wherein said financial notification data specify conditions for performing at least one of:
approving a request to execute said financial transaction;
denying a request to execute said financial transaction;
issuing a notification to said primary user in response to receiving a request to execute said financial transaction;
confirming an identity of said secondary user before approving said financial transaction; and
suspending future financial transaction activities of said secondary user.

9. The system of claim 7, wherein said financial notification data comprise a spending type, said spending type including at least one of:
a type of transaction;
a type of good or service;
a type of merchant;
a time of day; and
a location type.

10. The system of claim 9, wherein said spending type further comprises a spending limit.

11. The system of claim 7, wherein said notification is presented via at least one of:
a point of sale terminal;
a transaction receipt;
a computer screen;
a telephone;
postal mail;
a messaging application; and
an online service.

12. The system of claim 7, wherein said notification comprises at least one of:
an account balance;
an account shut-off;
a denial of a request to execute said financial transaction; and
a request to check an identification of said secondary user.

13. A database for providing control over transactions, said database storing financial notification data comprising:
an account identification;
a spending type including at least one of:
a type of purchase;
a type of merchant;
a time of day; and
a location type.

14. The database of claim 13, wherein said spending type further comprises a spending limit.

15. A storage medium encoded with machine-readable computer program code for providing control over transactions, said storage medium including instructions for causing a computer to implement a method, comprising:
prompting a primary user to input financial notification data, said financial notification data operable for defining transaction controls associated with a secondary user;
receiving and storing said financial notification data;
receiving data relating to a financial transaction from a point of sale, said data associated with said secondary user;
retrieving financial notification data related to said financial transaction; and
sending a notification to said point of sale based upon said data relating to said financial transaction.

16. The storage medium of claim 15, wherein said financial notification data specify conditions for performing at least one of:
approving a request to execute said financial transaction;
denying a request to execute said financial transaction;
issuing a notification to said primary user in response to receiving a request to execute said financial transaction;
confirming an identity of said secondary user before approving said financial transaction; and
suspending future financial transaction activities of said secondary user.

17. The storage medium of claim 15, wherein said financial notification data comprise a spending type, said spending type including at least one of:
a type of transaction;
a listing of items or services associated with said transaction;
a type of merchant;
a time of day; and
a location type.

18. The storage medium of claim 17, wherein said spending type further comprises a spending or usage limit.

19. The storage medium of claim 15, wherein said notification is presented via at least one of:
a point of sale terminal;
a transaction receipt;
a computer screen;
a telephone;
postal mail;
a messaging application; and
an online service.

20. The storage medium of claim 15, wherein said notification comprises at least one of:
an account balance;
an account shut-off;
a request for an additional authorization code;
a denial of a request to execute said financial transaction; and
a request to check an identification of said secondary user.
